(19) United States
(12) Patent Application Publication
(10) Pub. No.: US 2013/0227867 A1
(43) Pub. Date: Sep. 5, 2013

(54) Identification Tag with Resilient Fingers

(71) Applicant: Brandon Lee Furber, Fair Haven, NY (US)

(72) Inventor: Brandon Lee Furber, Fair Haven, NY (US)

(21) Appl. No.: 13/409,431

(22) Filed: Mar. 1, 2012

(51) Int. Cl. G09F 3/16

(52) U.S. Cl. 40/666

(57) ABSTRACT

An identification tag can be selectively attached and detached to a member along a pre-defined plane of connection of the identification tag. The identification tag includes a body portion and an attachment portion integral with the body portion. The attachment portion generally extends along a plane parallel to the pre-defined plane of connection and includes at least three resilient fingers. Each of the resilient fingers has an un-flexed position and is movable away from the un-flexed position to effectuate a temporary separation of the resilient fingers from one another so as to permit the selective attachment or detachment of the identification tag to the member.

### CROSS-REFERENCE TO RELATED APPLICATIONS

Not applicable.

### BACKGROUND

This disclosure relates to identification tags and, in particular, to identification tags having resilient features for connection to conduits or other slender members.

Tags or labels are sometimes used to mark items such as, for example, conduits or wires. Such tagging or labeling can be performed to permit an observer to identify the tagged item when the item is grouped with other items which cannot otherwise be readily distinguished from the tagged item. Similarly, tagging or labeling might be performed to inform an observer of a particular quality of the tagged item (e.g., that a line is energized) or to provide other markings to the item (e.g., to denote an item for removal or maintenance).

While tags and labels can be readily attached to many items, certain items are not well-suited for the kind of user interaction required to attach a tag, label, or other marker. As one example, an overhead line carrying an electric current cannot be directly handled without first de-energizing the line. Moreover, in some circumstances, the type of user interaction necessary to apply a tag, label, or other marker to an overhead line can require a user to climb a ladder or find some other way to position himself or herself at a location near the line for tagging.

Hence, a need exists for a tag, label, or other marker that can be readily attached to items that are, because of their qualities and/or their location, difficult to mark.

### SUMMARY

An identification tag is disclosed for selective attachment and detachment to a member along a pre-defined plane of connection of the identification tag. The identification tag includes a body portion and an attachment portion. The attachment portion is integral with the body portion, generally extends along a plane parallel to the pre-defined plane of connection, and includes at least three resilient fingers. Each of the resilient fingers has an un-flexed position and is movable away from this un-flexed position to effectuate a temporary separation of the resilient fingers from one another along the pre-defined plane of connection. This temporary separation of the resilient fingers permits the selective attachment or detachment of the identification tag to the member.

The body portion may be substantially planar and may display or support an indicia associated with the identification tag.

The identification tag may be composed of a substantially non-conductive material. This non-conductive material could be, for example, a polycarbonate plastic. The use of such a material allows the tag to be connected to an energized line because it is electrically insulative while still offering sufficient resiliency of the fingers.

Each of the resilient fingers may have three segments including a proximal segment, an intermediate segment, and a distal segment which may be sequentially connected. The proximal segment can be directly connected to the body portion of the identification tag and can extend away from the body portion such that, as the proximal segment extends away from the body portion of the identification tag, the proximal segment also extends away from the pre-defined plane of connection. The intermediate segment can then extend back toward the pre-defined plane of connection, while the distal segment can again extend away from the pre-defined plane of connection.

In some forms, the intermediate segment and distal segment can also continue to extend in a direction away from the body portion of the identification tag as they extend toward and away from the pre-defined plane of connection, respectively. The intermediate segment and the distal segment may each cross over the pre-defined plane of connection as they extend away from the body portion.

Each of the distal segments may have a contact surface configured for contact with the member during an attachment of the identification tag to the member. In order to facilitate contact with the member, the contact surface can have at least an area thereof in which a normal direction away from the area of the contact surface also extends away from the body portion.

The resilient fingers can include at least two resilient fingers substantially disposed on one side of the pre-defined plane of connection and at least one resilient finger positioned between these two resilient fingers that is substantially disposed on the other side of the pre-defined plane of connection. This ensures that the resilient fingers capture the member and that rotation of the identification tag relative to the member will not result in unintended detachment.

In order to direct flexure to certain parts of the resilient fingers, there may be a rib between the intermediate segment and the distal segment that inhibits a flexure of the intermediate segment relative to the distal segment. By making this joint comparably rigid to the rest of the finger, this promotes the concentration of any elastic deformation to the proximal segment as the resilient finger is moved away from the un-flexed position under an applied stress.

A surface feature may be formed on at least one surface of the proximal segment and the intermediate segment in which the at least one surface faces the pre-defined plane of connection. The surface feature may be, for example, a plurality of raised surfaces. This surface feature can be used to grip the member to prevent the movement or rotation of the tag relative to the member.

All of the resilient fingers could extend from one side of the body portion. A tab could be integrally formed on a side of the body portion that is opposite to the side of the body portion on which the resilient fingers are disposed. This tab may be adapted for connection to, for example, a hot stick for handling of the identification tag during selective attachment or detachment to the member.

A method of selectively attaching or detaching an identification tag of the types described herein is also disclosed. The identification tag is moved along the pre-defined plane of connection relative to the member. During this movement, the resilient fingers of the identification tag are moved away from the un-flexed position thereby effectuating the temporary separation of the resilient fingers from one another. This separation of the resilient fingers permits the passage of the member there through along the pre-defined plane of connection for the identification tag.

The temporary separation of the resilient fingers from one another may involve an insertion of the member between the resilient fingers to thereby attach the identification tag to the member. During the insertion, the member may contact a contact surface on a distal segment of each of the resilient fingers to effectuate the flexure of the resilient fingers away from the plane of connection thereby accommodating the reception the member.

The temporary separation of the resilient fingers from one another may involve a withdrawal of the member from between the resilient fingers, thereby detaching the identification tag from the member. During the withdrawal, the member may contact an intermediate segment of each of the resilient fingers to effectuate a flexure of the resilient fingers away from the plane of connection thereby accommodating the release of the member.

These and still other advantages of the invention will be apparent from the detailed description and drawings. What follows is merely a description of a preferred embodiment of the present invention. To assess the full scope of the invention, the claims should be looked to as the preferred embodiment is not intended to be the only embodiment within the scope of the claims.

### BRIEF DESCRIPTION OF THE DRAWINGS

FIG. 1 is a front, bottom, right side view of an identification tag attached to a member (member shown in phantom).

FIG. 2 is a front side view of the identification tag of FIG. 1.

FIG. 3 is a back side view of the identification tag of FIG. 1.

FIG. 4 is a left side view of the identification tag of FIG. 1.

FIGS. 5A through 5C are left side views of the identification tag of FIGS. 1 through 4 being attached to a member in which the resilient fingers are shown initially engaging the member, separating under an applied force during connection to receive the member between the resilient fingers, and then substantially returning to their original form to capture the member there between thereby attaching the identification tag to the member.

### DETAILED DESCRIPTION

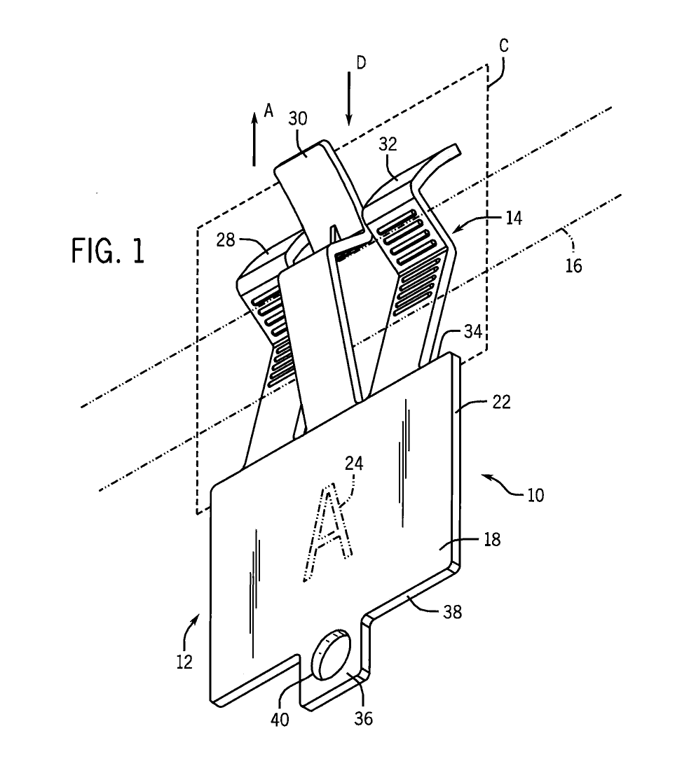

Referring first to FIGS. 1 through 4, one embodiment of an identification tag 10 is illustrated. Structurally, the identification tag 10 includes a body portion 12 and an attachment portion 14 which, as depicted in FIG. 1, can be used to attach the identification tag 10 to a member 16 (shown in phantom lines).

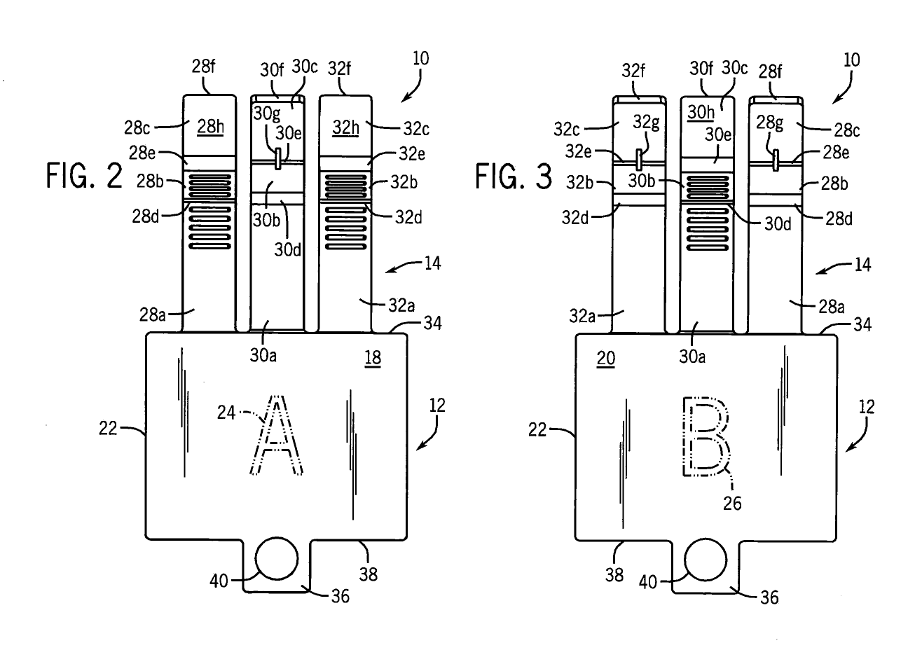

The body portion 12 of the identification tag 10 is generally plate-like having a front planar surface 18 (as shown in FIGS. 1 and 2), a rear planar surface 20 (as shown in FIG. 3), and a peripheral edge 22 that generally defines the outer limits of the body portion 12. As the body portion 12 is plate-like, the front planar surface 18 and the rear planar surface 20 are generally parallel with one another, albeit on opposing sides of the body portion 12.

One or both of the front planar surface 18 and the rear planar surface 20 can display indicia. In the example shown, the letter “A” is provided as a front indicia 24 while the letter “B” is provided as a rear indicia 26. However, any type of indicia could be provided on one or both of the surfaces including, but not limited to, numbers, letters, pictures, images, symbols, and so forth. Because both the front indicia 24 and the rear indicia 26 are only used as examples of potential indicia, they are both displayed in phantom lines in FIGS. 1 through 3. Such indicia could be created in any of a number of ways including, but not limited to, attachment of the indicia on the surface of the body portion 12 (e.g., adhesive attachment of the indicia to the surface), printing the indicia on the surface either by machine or by hand, molding the material of the body portion 12 around the indicia (e.g., encapsulating the indicia in a transparent or semi-transparent material), and so forth.

In some embodiments, no indicia need be provided with the body portion 12. It is possible that the identification tag 10 itself or some feature of the identification tag 10 other than indicia may be instructive to an observer. For example, a color of the identification tag 10 may identify the identification tag 10 and the item to which it is attached.

Integrally formed with the body portion 12 of the identification tag 10 is the attachment portion 14. In the specific form shown, the attachment potion 14 has three resilient fingers 28, 30, and 32 which can be reversibly attached to a member 16 (shown in phantom lines in FIG. 1) such as for example a conduit or line. The resilient fingers 28, 30, and 32 are all disposed along an upper linear portion 34 of the peripheral edge 22.

As illustrated, each of these three resilient fingers 28, 30 and 32 is divided into three segments: a proximal segment 28a, 30a, and 32a; an intermediate segment 28b, 30b, and 32b; and a distal segment 28c, 30c, and 32c, respectively. As depicted, these segments are sequentially connected to one another.

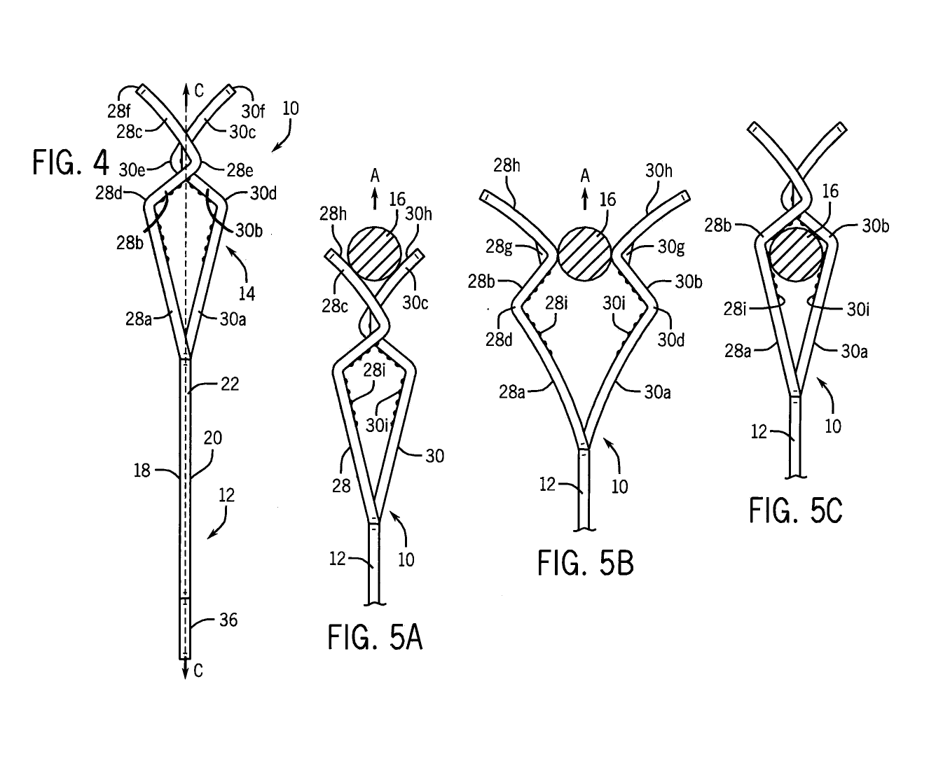

Each of these resilient fingers 28, 30, and 32 generally extend away from the body portion 12 of the identification tag 10 along what will be referred to herein as the pre-defined plane of connection C for the identification tag 10. In the particular identification tag 10 illustrated, this pre-defined plane of connection C (which is drawn in broken lines in FIGS. 1 and 4) is generally parallel to the front planar surface 18 and the rear planar surface 20 of the body portion 12. During attachment or detachment of the identification tag 10 onto the member 16, the identification tag 10 is moved along this predefined plane of connection C. During attachment, the identification tag 10 is moved in the direction of arrow A which is denoted in FIG. 1 such that the resilient fingers 28, 30, and 32 can come into contact with the member 16. During detachment, the identification tag 10 is moved in the opposite direction for detachment denoted by arrow D in FIG. 1.

Returning now to the description of the resilient fingers 28, 30, and 32, the proximal segments 28a, 30a, and 32a are directly connected to the body portion 12 of the identification tag 10. As the proximal segments 28a, 30a, and 32a extend away from the body portion 12, the proximal segments 28a, 30a, and 32a also extend away from the pre-defined plane of connection C (as is best illustrated in the side view of FIG. 4).

At a first bend 28d, 30d, and 32d in each of the resilient fingers 28, 30, and 32, each of the proximal segments 28a, 30a, and 32a is joined, connected, or linked to the intermediate segments 28b, 30b, and 32b, respectively. In the intermediate segments 28b, 30b, and 32b, the resilient fingers 28, 30, and 32 continue to extend away from the body portion 12. However, unlike the proximal segments 28a, 30a, and 32a, the intermediate segments 28b, 30b, and 32b extend back towards the pre-defined plane of connection C, at least initially. In one form, it is contemplated that, as the intermediate segments 28b, 30b, and 32b continue to extend away from the body portion 12, the intermediate segments 28b, 30b, and 32b can pass through the pre-defined plane of connection C.

At a second bend 28e, 30e, and 32e in the resilient fingers 28, 30, and 32, each of the intermediate segments 28b, 30b, and 32b is joined, connected, or linked to the distal segments 28c, 30c, and 32c, respectively. The distal segments 28c, 30c, and 32c also continue to extend away from the body portion 12 of the identification tag 10 towards terminal ends 28f, 30f, and 32f, but also generally extend away from the pre-defined plane of connection C. It should be noted that in the instance in which the corresponding intermediate segment 28b, 30b, and 32b has previously crossed over the pre-defined plane of connection C, the connected distal segment 28c, 30c, and 32c may need to briefly extend back toward and over the pre-defined plane of connection C, prior to extending away from it.

This back and forth extension of the resilient fingers 28, 30, and 32 throughout the segments gives the resilient fingers 28, 30, and 32 a zig-zag appearance when viewed laterally or from the side as in FIG. 4. It should be appreciated that while each of the segments are generally depicted as being generally planar and meeting at bends, that the resilient fingers may be formed to curve or to be S-shaped and be capable of the functionality described below with respect to reversible connection. Accordingly, the described segments should not be so limited as to those shapes and forms illustrated in the figures. Moreover, the number and positions of the resilient fingers can differ from that shown in the figures.

The fingers 28, 30, and 32 are described as being resilient which means that they are able to recoil or spring back into shape after bending, stretching, or being compressed. In the context of this disclosure, the fingers 28, 30, and 32 originally have an un-flexed position or a substantially un-flexed position as shown in FIGS. 1 through 4. During attachment or detachment of the identification tag 10, as will be described in greater detail below, the fingers 28, 30, and 32 can be moved away from the un-flexed position thereby effectuating a temporary separation of the resilient fingers 28, 30, and 32 from one another along the pre-defined plane of connection C.

This temporary separation will permit the selective attachment or detachment of the identification tag 10 to the member 16. In terms of resiliency, what this means is that the fingers 28, 30, and 32 are to be made sufficiently resilient (by, for example, material selection or selection of finger dimensions such as thickness, width, and so forth) so as to be able to accommodate the passage of a member 16 between the fingers for attachment or detachment. Moreover, the fingers should be elastically deformable within this range of movement so that, upon withdrawal of the member 16, the fingers 28, 30, and 32 will return to their un-flexed position or, upon reception of the member 16 between the fingers 28, 30, and 32, the fingers 28, 30, and 32 will return to either the un-flexed position and have captured the member 16 there between or will move back toward the un-flexed position even if they do not return all the way because the member 16 is too large to permit such movement. To be resilient, however, does not mean that the fingers need to be unbreakable over all potential ranges of motion and under all exerted forces.

In order to make some portions of the resilient fingers 28, 30, and 32 stiffer than other portions, there may be ribs 28g, 30g, and 32g or other structural features formed on the fingers 28, 30, and 32. For example, in the embodiment illustrated, a rib 28g, 30g, and 32g extends vertically between each of the intermediate segments 28b, 30b, and 32b and their corresponding distal segments 28c, 30c, and 32c at the second bends 28e, 30e, 32e. The inclusion of these ribs 28g, 30g, and 32g help to prevent the flexure of the distal segments relative to the intermediate segments under an applied force and redirects any applied force to the more resilient portions of the fingers (in this instance, the first bends 28d, 30d, and 32d and/or the proximal segments 28a, 30a, and 32a).

At a bare minimum, two fingers might be enough to establish and maintain a connection with a member, if the fingers are spaced sufficiently close to one another and disposed in alternating orientations with respect to the pre-defined plane of connection C. Assuming an inter-finger gap when the fingers are substantially un-flexed is smaller than the member 16, the member 16 will not be able to pass through the inter-finger gap by twisting without first surpassing some threshold amount of applied force.

The presence of a third finger provides additional benefit in that, among other things, it can restrict or define the orientation of the identification tag 10 relative to the member 16 such that the body portion 12 is displayed at a predictable orientation relative to the member 16. Moreover, if there are three or more resilient fingers in which there are at least two alterations in orientations of the resilient fingers relative to the body portion 12, then the resilient fingers can be spaced further apart from one another along the portion of the peripheral edge 22 without limiting functionality. For the sake of redundancy or to provide secure attachment of the identification tag 10 when the body portion 12 is relatively long and/or heavy, additional fingers (e.g., four, five or more fingers) could be provided.

In some embodiments, the identification tag 10 can also have a tab 36 formed along a lower linear portion 38 of the peripheral edge 22. In the illustrated embodiment, the tab 36 is a rectangular projection protruding from the lower linear portion 38 of the peripheral edge 22 and has a circular opening 40 that extends through the tab 36 in a direction generally perpendicular to the direction of extension of the peripheral edge 22. During attachment or detachment, a hot stick or other tag-handling implement that electrically insulates the operator from the tag 10 can engage the tab 36 and potentially the opening 40 to facilitate the gripping of the tag 10.

Now, with additional reference to FIGS. 5A through 5C, the connection, and more specifically the attachment, of the identification tag 10 to the member 16 is illustrated in detail in step-wise fashion. This attachment happens along the pre-defined plane of connection C in the attachment direction A.

Looking first at FIG. 5A, the identification tag 10 is shown being brought into initial contact with the member 16 in which the resilient fingers 28, 30, and 32 are in an un-flexed position. As noted above, because the member 16 may be an energized line, wire, conduit, or so forth, the identification tag 10 may be picked up and handled using a hot stick tool that electrically isolates the user from item (in this case, the identification tag 10) being handled.

Upon movement of the identification tag 10 toward the member 16, the first portions of the identification tag 10 to contact the member 16 are the contact surfaces 28h, 30h, and 32h which are disposed on the distal segments 28c, 30c, and 32c of the resilient fingers 28, 30, and 32. The contact surfaces 28h, 30h, and 32h each have at least an area thereof in which a normal direction away from the area of the contact surface 28h, 30h, and 32h extends away from the body portion 12. When viewed from the side of the tag 10, these contact surfaces 28h, 30h, and 32h also define a V-shape which initially contacts the member 16.

Under the continued application of force in the direction of attachment A, the resilient fingers 28, 30, and 32 are forced into contact with the member 16. As shown in FIG. 5B, this results in the resilient fingers 28, 30, and 32 of the identification tag 10 temporarily separating from one another under the applied force and the resilient fingers 28, 30, and 32 being moved away from the pre-defined plane of connection C. This separation of the resilient fingers 28, 30, and 32 to a flexed position permits the member 16 to pass between the second bends 28e, 30e, and 32e of the resilient fingers 28, 30, and 32 and, ultimately, into a space between the proximal segments 28a, 30a, and 32a and the intermediate segments 28b, 30b, and 32b.

It should be observed that in FIG. 5B, the flexure of the resilient fingers 28, 30, and 32 primarily occurs in the proximal segments 28a, 30a, and 32a and at the first bends 28d, 30d, and 32d. As noted above, this concentration of the flexure occurs because of the presence of ribs 28g, 30g, and 32g. This can be advantageous because it means that the ends of the resilient fingers 28, 30, and 32 can be comparably rigid to the portions nearest to the body portion 12. This can reduce the likelihood of segments of the resilient fingers 28, 30, and 32 behaving like an accordion during attachment and potentially damaging one or more of the fingers 28, 30, and 32.

After the member 16 passes between the second bends 28e, 30e, and 32e, the resilient fingers 28, 30, and 32 snap back into place and the member 16 is captured between the resilient fingers 28, 30, and 32 as depicted in FIG. 5C. In this position, a plurality of bumps or raised surfaces 28i, 30i, and 32i on inner sides of the proximal segments 28a, 30a, and 32a and the intermediate segments 28b, 30b, and 32b can engage the member 16 to grip the member 16 to prevent movement of the tag 10 relative to the member 16.

While the resilient fingers 28, 30, and 32 are shown as returning to the un-flexed position after attachment in FIG. 5C, it is contemplated that for a sufficiently large member, the resilient fingers 28, 30, and 32 might move back towards, although not completely reach, their un-flexed positions if that the member is so large as to prevent a full return to this position.

In order to detach the tag 10, the steps of FIGS. 5A to 5C can be performed in reverse. A hot stick could be used to grip the tag 10 or the tab 36 of the tag 10. The hot stick could pull the tag 10 in a direction D, which is opposite to the direction of attachment A (at least relative to the pre-defined plane of connection C, which is relative to the tag 10). The applied force of the pull would cause the member 16 to engage the intermediate segments 28b, 30b, and 32b to cause the resilient fingers 28, 30, and 32 to temporarily separate from one another such that the member 16 could be extracted from the resilient fingers 28, 30, and 32. Then the resilient fingers 28, 30, and 32 having no force applied thereto, would return to their original un-flexed position.

Accordingly, an identification tag and a related method of using the tag are provided. Among other things, this tag offers a safe and quick way to label or identify a member that is otherwise difficult to mark, such as an energized wire. This helps the user to avoid direct contact with the member to which the tag is to be attached, which in some instances can be problematic or required de-energization of the member and downtime of the underlying system of which the member is a part. Moreover, the identification tag has a construction which permits for the reversible attachment and reuse of the tag making it particularly versatile.

Many modifications and variations to this preferred embodiment will be apparent to those skilled in the art, which will be within the spirit and scope of the invention. Therefore, the invention should not be limited to the described embodiment. To ascertain the full scope of the invention, the following claims should be referenced.

What is claimed is:

1. An identification tag for selective attachment and detachment to a member along a pre-defined plane of connection of the identification tag, the identification tag comprising:
a body portion; and
an attachment portion integral with the body portion, the attachment portion generally extending along a plane parallel to the pre-defined plane of connection and including at least three resilient fingers;
wherein each of the resilient fingers has an un-flexed position and is movable away from the un-flexed position thereby effectuating a temporary separation of the resilient fingers from one another along the pre-defined plane of connection so as to permit the selective attachment or detachment of the identification tag to the member.

2. The identification tag of claim 1, wherein each of the resilient fingers includes three segments:
a proximal segment connected to the body portion that extends away from the body portion such that as the proximal segment extends away from the body portion of the identification tag the proximal segment also extends away from the pre-defined plane of connection;
an intermediate segment extending back toward the pre-defined plane of connection;
a distal segment extending away from the pre-defined plane of connection.

3. The identification tag of claim 2, wherein the proximal segment is directly connected to the body portion of the identification tag.

4. The identification tag of claim 2, wherein the proximal segment, the intermediate segment, and the distal segment are sequentially connected and wherein the intermediate segment and distal segment also extend in a direction away from the body portion of the identification tag.

5. The identification tag of claim 2, wherein the intermediate segment and the distal segment each cross over the pre-defined plane of connection.

6. The identification tag of claim 2, wherein each of the distal segments each have a contact surface configured for contact with the member during an attachment of the identification tag and wherein the contact surface has at least an area thereof in which a normal direction away from the area of the contact surface extends away from the body portion.

7. The identification tag of claim 2, wherein the at least three resilient fingers include at least two resilient fingers substantially disposed on one side of the pre-defined plane of connection and at least one resilient finger positioned there between that is substantially disposed on the other side of the pre-defined plane of connection.

8. The identification tag of claim 2, further comprising a rib between the intermediate segment and the distal segment that inhibits a flexure of the intermediate segment relative to the distal segment and promotes concentration of any elastic deformation to the proximal segment when the resilient finger is moved away from the un-flexed position.

9. The identification tag of claim 2, further comprising a surface feature formed on at least one surface of the proximal segment and the intermediate segment in which the at least one surface is facing the pre-defined plane of connection.

10. The identification tag of claim 9, wherein the surface feature is a plurality of raised surfaces formed on the at least one surface.

11. The identification tag of claim 1, wherein the body portion is substantially planar.

12. The identification tag of claim 1, wherein the identification tag is composed of a substantially non-conductive material.

13. The identification tag of claim 1, wherein the at least three resilient fingers all extend from one side of the body portion.

14. The identification tag of claim 13, further comprising a tab integrally formed on a side of the body portion that is opposite the side of the body portion on which the at least three resilient fingers are disposed, the tab being adapted for connection to a hot stick for handling of the identification tag during selective attachment or detachment.

15. The identification tag of claim 1, wherein the body portion displays an indicia associated with the identification tag.

16. A method of selectively attaching or detaching the identification tag of claim 1 to or from a member along the pre-defined plane of connection of the identification tag, the method comprising:
moving the identification tag along the pre-defined plane of connection relative to the member;
moving the at least three resilient fingers of the identification tag away from the un-flexed position thereby effectuating the temporary separation of the resilient fingers from one another to permit the passage of the member there through along the pre-defined plane of connection.

17. The method of claim 16, wherein the temporary separation of the resilient fingers from one another involves an insertion of the member between the resilient fingers, thereby attaching the identification tag to the member.

18. The method of claim 17, wherein, during the insertion, the member contacts a contact surface on a distal segment on each of the resilient fingers to effectuate the flexure of the resilient fingers away from the plane of connection.

19. The method of claim 16, wherein the temporary separation of the resilient fingers from one another involves a withdrawal of the member from between the resilient fingers, thereby detaching the identification tag from the member.

20. The method of claim 19, wherein, during the withdrawal, the member contacts an intermediate segment of each of the resilient fingers to effectuate a flexure of the resilient fingers away from the plane of connection.
